(19) United States
(12) Patent Application Publication
(10) Pub. No.: US 2006/0225286 A1
(43) Pub. Date: Oct. 12, 2006

(54) Razor with integrated rinsing scoop

(76) Inventor: Louis D. Tomassetti, Pompano Beach, FL (US)

Correspondence Address: Robert M. Downey, P.A.;Ste. 300, 601 S. Federal Hwy., Boca Raton, FL, 33432, US

(21) Appl. No.: 11/451,554

(22) Filed: Jun. 12, 2006

Related U.S. Application Data
(63) Continuation of application No. 10/389,855, filed on Mar. 14, 2003.

(51) Int. Cl. B26B 19/44

(52) U.S. Cl. 30/41.5

(57) ABSTRACT

A razor includes a handle, a neck extending from the top of the handle and a blade-carrying razor head pivotally fitted on the distal end portion of the neck. The neck is formed to include an integrated scoop for directing a stream of water through the blade-carrying razor head in a fanned array, providing an enhanced flushing action to remove debris and residue which accumulates on the blade surfaces and between the blades.

This application is a continuation application of co-pending patent application Ser. No. 10/389,855 filed on Mar. 14, 2003.

### BACKGROUND OF THE INVENTION

1. Field of the Invention

This invention relates to a razor for shaving and, more particularly, to a razor having a handle, a blade-carrying head and a neck extending between the handle and the head and wherein the neck is formed to include an integrated scoop that directs water through the blade-carrying head and between the blades in a flushing action for removal of debris and residue that accumulates on the blade surfaces when shaving.

2. Discussion of the Related Art

Over the years, razors have been developed, marketed and improved to address the needs of the consumer. In particular, various improvements have been made to razors in order to produce a closer, more uniform shave with less nicking by allowing the blade-cutting surface to conform to the various configurations of anatomical skin surfaces. To address this need, many razor designs have been proposed which include a pivoting blade-carrying head which permits the cutting edge of the blade to more closely follow the skin surface contour without nicking the skin. Examples of razors with pivoting heads can be found in U.S. patents to Ferraro, U.S. Pat. No. 4,709,477; Edson, U.S. Pat. No. 3,593,416; and Trotta, U.S. Pat. No. 4,324,041. More recent examples of pivoting blade heads can be found in U.S. Pat. Nos. 5,784,790 and 5,787,586, both owned by the Gillette Company.

The present invention provides a razor that has a handle, a neck and a pivoting blade head attached to the end of the neck. The head may carry a single blade or, alternatively, multiple blades in parallel spaced relation to one another in a similar manner as other known multiple blade razor heads that have become increasingly popular in today's shaving market. The neck of the razor is formed to include an integrated scoop that is structured and disposed to direct a stream of water, running from a faucet, in a fanned array and through the head to thoroughly flush debris and residue from the blade surfaces.

### OBJECTS AND ADVANTAGES OF THE INVENTION

With the foregoing in mind, it is a primary object of the present invention to provide a razor with a scoop formed on the neck to direct a stream of water through the blade-carrying razor head in a manner which enhances flushing action in order to thoroughly rinse debris and residue which accumulates on the blades.

It is still a further object of the present invention to provide a razor which may be manufactured as a disposable item, and wherein the razor includes a pivoting blade-carrying head and a neck that is formed with an integrated scoop for directing a stream of running water through the blade-carrying head in a manner that enhances flushing and removal of debris and residue from the blade surfaces and between the blades.

These and other objects and advantages of the present invention are more readily apparent with reference to the following detailed description taken in conjunction with the accompanying drawings.

### SUMMARY OF THE INVENTION

The present invention is directed to a razor having a handle, a neck extending from the top of the handle and a blade-carrying razor head pivotally fitted on the distal end portion of the neck. The neck is formed to include an integrated scoop for directing a stream of water through the blade-carrying razor head in a fanned array, providing an enhanced flushing action to remove debris and residue which accumulates on the blade surfaces and between the blades.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view of the razor of the present invention, in accordance with a preferred embodiment thereof;

FIG. 2 is a front elevational view of the razor of FIG. 1;

FIG. 3 is an isolated side elevational view of the distal end of the razor;

FIG. 4 is a plan view, in partial cross-section, taken along the plane as indicated by the arrows 4-4 in FIG. 3; and

FIG. 5 is an isolated elevational view of the distal end of the neck and pivoting blade-carrying head of the razor, wherein pivoting movement of the blade-carrying head is illustrated by the phantom lines and directional arrows.

Like reference numerals refer to like parts throughout the several views of the drawings.

### DETAILED DESCRIPTION OF THE PREFERRED EMBODIMENTS

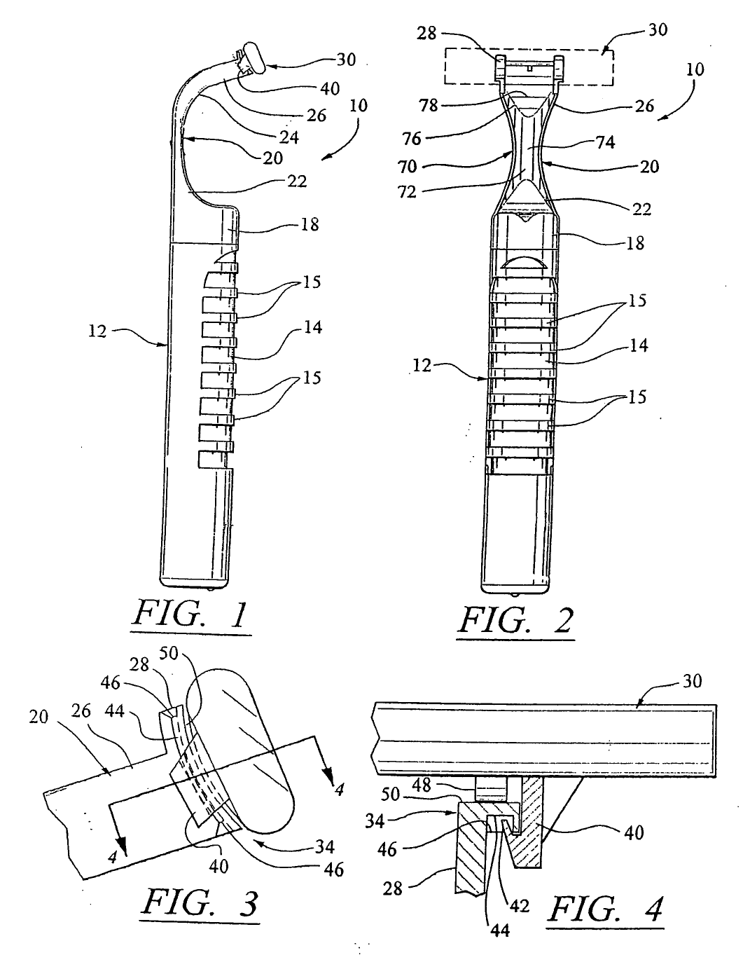

Referring to the several views of the drawings, and initially FIGS. 1 and 2, the razor of the present invention is shown and is generally indicated as 10. The razor 10 includes a handle 12 having a central portion 14 defining a grip zone and an upper portion 18. The central portion 14 of the handle 12 may be provided with grip members such as a plurality of parallel, spaced ribs 15 to discourage slipping and to enhance the grasp of the handle within the user's hand.

The razor 10 also has a neck 20 that extends upwardly from the upper portion 18 of the handle 12. The neck 20 includes a proximal portion 22 adjacent to the upper portion 18 of the handle 12 and a distal portion 26 terminating at a distal end 28. In a preferred embodiment, a bend 24 is formed between the proximal portion 22 and distal portion 26. As shown in FIGS. 1 and 2, the neck 20 is integrally formed with the upper portion 18 of the handle.

A blade-carrying head 30 having one or more blades is pivotally attached to the distal end 28 of the neck 20. As seen in FIG. 1, the bend 24 in the neck 20 positions the blade-carrying head 30 at an optimal orientation relative to the handle 12 for engagement with the skin surface when shaving.

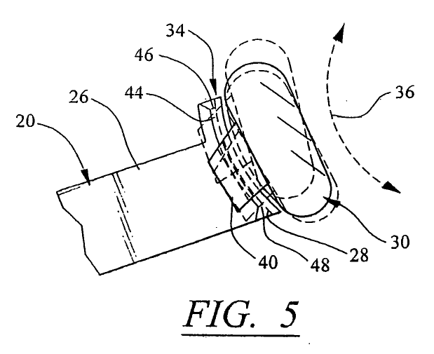

The blade-carrying head 30 is pivotally fitted to the distal end 28 of the neck 20. Specifically, pivotal attachment means 34 are provided for securing the blade-carrying head 30 to the distal end 28 in a manner which permits pivoting movement of the head 30 through an arcuate path, as indicated by the directions arrows 36 in FIG. 5. In a preferred embodiment, the pivotal attachment means 34 is defined by cooperating structure on both the head 30 and the distal end 28 of the neck. Specifically, a pair of parallel arm members 40 extend from the back of the blade-carrying head 30 and include barbs 42 formed on an outboard side. The barbs 42 on each of the parallel arm members 40 are structured and disposed to be received within arcuate grooves 44 on the distal end 28 of the neck 20. The arcuate grooves 44 function as a track for guiding the barbs 42 therealong to achieve the pivoting arcuate movement of the head 30. Shoulders 46 at opposite ends of the arcuate grooves 44 limit travel of the arm members 40 relative to the distal end 28 of the neck, preventing separation of the head 40 from the distal end 28. A pair of knuckles 48 on the back of the blade-carrying head 30 engage a concave surface 50 on the distal end 28 of the neck, on an opposite side of the arcuate grooves 44. The knuckles 48 serve to capture the head 30 on the distal end 28 by sandwiching the distal end 28 between the barbs 42 and respective knuckles 48 so that the head 30 does not separate from the distal end 28. The knuckles 48 engage the respective concave surfaces 50 on the distal end 28, maintaining contact therewith for sliding movement along the concave surfaces 50 as the head 30 travels through the arcuate path of pivoting movement.

As seen in FIGS. 1 and 2, the neck 20 is formed and configured to provide a scoop structure 70 formed in the front face of the neck for directing a stream of water through the blade-carrying razor head 30 in a fanned array in order to provide an enhanced flushing action which removes accumulated debris and residue from the blades. As seen in FIG. 2, the scoop structure 70 includes a concave surface 72 which narrows at area 74 to provide a funneling action. The scoop then widens at zone 76 to direct the flow of water into a fanned array and over flat surface 78 for passage between the blades on the head 30, thereby flushing and removing any accumulated debris and residue therefrom. It is noted that the scoop structure 70 also provides a convenient means for hanging the razor 10 on a hook or other projecting structure above a vanity or in a shower.

While the instant invention has been shown and described in accordance with a preferred and practical embodiment thereof, it is recognized that departures from the instant disclosure are contemplated within the spirit and scope of the present invention. Accordingly, the scope of protection of the invention is not limited except as defined in the following claims as interpreted under the doctrine of equivalents.

What is claimed is:

1. A razor comprising:
a handle having a central portion and an upper portion;
a neck extending from said upper portion of said handle and including a proximal portion and a distal portion terminating at a distal end;
a head fitted to said distal end of said neck and having one or more blades carried thereon; and
said head being formed and configured to include an integrated scoop, and said scoop being structured and disposed to direct a stream of water through said head to remove accumulated debris and residue from said one or more blades.

2. The razor as recited in claim 1 wherein said scoop is structured and disposed to direct the stream of water in a fanned array through said head.

3. The razor as recited in claim 1 wherein said scoop is integrally formed in said neck as a concave channel between said proximal portion and said distal portion.

4. The razor as recited in claim 3 wherein said concave channel includes a narrow section.

5. The razor as recited in claim 1 wherein said head is pivotally movable relative to said distal end of said neck through a range of arcuate movement.

6. The razor as recited in claim 1 wherein said neck includes a bend between said proximal portion and said distal portion.

7. The razor as recited in claim 1 wherein said central portion of said handle includes an arrangement of grip members for promoting grasping of the handle.

8. A razor comprising:
a handle having a central portion and an upper portion;
a neck extending from said upper portion of said handle and including a proximal portion and a distal portion terminating at a distal end;
a head fitted to said distal end of said neck and having at least one blade; and
a scoop integrally formed in said neck for directing water flow through said head to rinse said at least one blade.

9. The razor as recited in claim 8 wherein said scoop is structured and disposed to direct the water flow in a fanned array through said head to rinse said at least one blade.

10. The razor as recited in claim 8 wherein said head includes a plurality of blades.

11. The razor as recited in claim 10 wherein said scoop is structured and disposed to direct the water flow through said head and between said plurality of blades.

12. The razor as recited in claim 8 wherein said scoop is integrally formed in said neck as a concave channel between said proximal portion and said distal portion.

13. The razor as recited in claim 12 wherein said concave channel includes a narrow section.

14. The razor as recited in claim 13 wherein said concave channel further includes a widening section adjacent to said narrow section for directing the water flow in a fanned array through said head.

15. The razor as recited in claim 8 wherein said head is pivotally movable relative to said distal end of said neck through a range of arcuate movement.

16. The razor as recited in claim 8 wherein said neck includes a bend between said proximal portion and said distal portion.

17. A razor comprising:
a handle having a central portion and an upper portion;
a neck extending from said upper portion of said handle and including a proximal portion and a distal portion terminating at a distal end;
a head fitted to said distal end of said neck and including at least one blade; and
a scoop integrally formed in said neck and including a concave channel between said proximal portion and said distal portion for directing water flow through said head to rinse said at least one blade.

18. The razor as recited in claim 17 wherein said head includes a plurality of blades.

19. The razor as recited in claim 18 wherein said scoop is structured and disposed to direct the water flow through said head and between said plurality of blades to rinse said plurality of blades.
